(19) United States
(12) Patent Application Publication
(10) Pub. No.: US 2011/0240234 A1
(43) Pub. Date: Oct. 6, 2011

(54) SLIDING DOOR WITH STACKABLE PANELS

(76) Inventor: Stephan Jans, Kriens (CH)

(21) Appl. No.: 13/077,214

(22) Filed: Mar. 31, 2011

(30) Foreign Application Priority Data
Apr. 1, 2010 (EP) 10158991.9

(51) Int. Cl. E06B 5/00

(52) U.S. Cl. 160/202

(57) ABSTRACT

A sliding door comprises a plurality of guide panels guided in a straight guide rail track of a guide rail. During an opening movement along a slide axis, the door panels are deflectable by an abutment into an angled guide rail track of the guide rail along a stacking axis so that the door panels can be stacked approximately in the direction of the slide axis and during a closing movement can be unstacked by deflection into the straight guide rail track.

### CROSS-REFERENCE TO RELATED APPLICATION

This application claims priority to European Patent Application No. 10158991.9, filed Apr. 1, 2010, which is incorporated herein by reference.

### FIELD

The present disclosure relates to a sliding door such as finds use in, for example, an elevator installation as a cage door or storey door.

### BACKGROUND

Patent Specification FR-1025073 discloses a sliding door consisting of a plurality of individually pivotable door panels. These door panels are in the closed state of the sliding door arranged with their longitudinal sides in a line so as to form a planar surface and in the opened state of the sliding door the door panels form a packet with longitudinal side lying against longitudinal side. The thus-stacked packet of the individual door panels in the finally opened state demands little space, but due to the fact that the stacking takes place by a concertina movement or by a zigzag-shaped deflection of the individual door panels a considerable amount of room can be required during the opening or closing movement of the sliding door. Beyond that it can be necessary to arrange for this zigzag-shaped arrangement a guide rail, which can be placed centrally, offset by half the length of a door panel inwardly of the cage from the cage threshold in order to avoid the so-called drawer effect. In other words, the solution disclosed in this patent specification FR-1025073 shows a relatively advantageous space-saving opened state, but a disadvantageous space-consuming path towards that and back again.

A sliding door has become known from U.S. Pat. No. 4,787,119 in which the door panels in the opening and closing movement are guided at one end along a first guide rail and at the other end along a second guide rail and coupled together. In the stacking region the first and second guide rails run at an angle relative to the opening and closing direction, wherein the door panels are decoupled from one another in the stacking region.

A sliding door has become known from U.S. Pat. No. 5,022,454 in which the door panels during the opening and closing movement inter-engage at the ends and are parked independently of one another in the stacking region. The door panels are guided and transported by means of guide rails present at each panel edge.

### SUMMARY

At least some embodiments disclose an arrangement of a plurality of door panels which can be stacked in a direction of sliding. The individual door panels for this purpose during the opening and closing movement do not execute an approximately 90 degree pivot movement, but maintain their longitudinal orientation approximately identical to the direction of sliding.

Provided for this purpose is a guide rail in which a guide rod is movably guided. This guide rod is at the same time insertable into a gate guide which at each door panel is fixedly connected with a base plate of the individual door panel.

At least two of these guide rods are fastened to a first door panel or to its base plate, for example by means of a rod mount, preferably in the form of a clamp fastenable to the base plate. This clamp can fixedly grip the guide rod, but optionally in such a manner that the guide rod can rotate about its own longitudinal axis. A rotation of the guide rod can prove advantageous for easy running of the sliding door. In addition, guide rollers or ball bearings can be optionally arranged at the guide rods, not only in a lower guide rail, but also in an optional upper guide rail.

The first guide rod of the first door panel is inserted in the guide rail and the gate guide of the first door panel. The second guide rod of this first door panel is in turn similarly inserted in the guide rail, but also in the gate guide of a second, adjacent door panel. The first and second door panels slightly overlap and thus stand at a slight angle to the guide rail.

The second door panel thus has a guide rod (the second of the first door panel) movably arranged in its gate guide and a further, third guide rod which in turn is fixedly arranged at the base plate of the second door panel. This third guide rod is on the one hand movably arranged in the guide rail and on the other hand again in the gate guide of a third door panel. A fourth guide rod is inserted in the guide rail, fixedly at the third panel and movably in the gate guide of a fourth door panel, etc. In this manner a guided, but at the same time displaceable connection between the individual door panels is realized.

The guide rail or—in the case of a lower and an upper-guide rails forms or form an approximate right angle. Consequently, the guide rod fixedly arranged at an outermost door panel hits against an abutment during an opening movement of the sliding door. This abutment can alternatively be formed in such a manner that it co-operates—possibly in the form of a deflecting pin—with the outer end face of the outermost door panel so that no unnecessary friction or even clamping effect builds up between the guide rod fixedly arranged at this outermost door panel and the new guide rail direction. In some cases the angle of the guide rail is rounded off and/or furnished with an obliquely arranged slide surface.

Since the individual door panels are arranged to overlap at a slight angle with respect to the guiding guide rail, the abutment has the effect that the guide rods respectively and movably inserted into the gate guides are pushed together due to the simultaneous constrained guidance in the guide rail and are urged laterally into the new, approximately right-angled guide rail track.

In order to avoid increased friction or even a clamping effect in the first, straight guide rail track, a further embodiment of a sliding door comprises a detent mechanism at the outermost point within the gate guide track for the mobile guide rods. This detent mechanism holds the movable guide rod in the gate guide of the outermost door panel with a smaller holding force, the adjacent door panel with a higher holding force, a door panel adjacent thereto with an even higher holding force and so forth until a highest holding force at that door panel at which a drive is placed. Through this coupling of detent mechanisms retaining with different strengths it can be achieved that the opening and closing movement of the sliding door always begins with pushing together of the outermost door panel and progresses successively with the respectively adjacent door panel.

A further embodiment of a sliding door provides a torsion stop to counter torsion or twisting of the door panels in the opened state. This torsion stop can be designed as a further rod which is fastened with the mobile guide rod preferably by coupling and is similarly inserted in the gate guide. The torsion stop can, however, also be a spring or a store of gravitational force which presses lightly against the outermost door panel. In principle, a torsion stop suffices merely at the outer door panel moreover, for example, in the form of a guide carriage which does not permit twisting of this door panel.

The spring or store for gravitational force in this manner represents not only a torsion stop, but also an assisting aid for guiding the stacked door panels during closing of the sliding door, i.e., during guidance of the door panels back from the angled guide rail track into the straight guide rail track closing the cage door.

In some embodiments, the drive of the sliding door can basically be carried out merely at the first or innermost door panel, for example by means of a chain, a cable drum or an entrainer. Another embodiment of a sliding door provides, however, a drive for each individual door panel in that a pin is insertable into a U-shaped entrainer. As long as the door panel is disposed along the straight guide rail track, the pin is seated locked in the U-shaped entrainer. However, as soon as the movable guide rod arranged in the gate guide urges a door panel laterally away into the guide rail track arranged approximately at right angles the pin is also taken out of the U-shaped entrainer. In this manner it is ensured that merely only those drive panels are driven which are directly disposed along the straight guide rail track and the drive of a respective door panel is taken out of action in good time before reaching the abutment when it is urged into the angled guide rail track.

A sliding door can be designed as a single sliding door over the entire side of the elevator cage, but also as a double sliding door. In the case of a drive placed merely at one door panel, for a double sliding door the two center innermost door panels can be driven in opposite sense. The double sliding door can be formed from two symmetrical halves, but also from two or more parts of different width.

For avoidance of noise, provision can be made for the guide rollers, the mechanical parts of the drive, for example the pins and the U-shaped entrainers, and the abutments to be formed from a relative soft, rubber-like synthetic material or coated therewith.

The described individual features of various embodiments can be combined with one another to form a sliding door or doors, thus, for example, the described different embodiments of door panels can be combined with the described different embodiments of torsion stops and with the described different embodiments of drives.

In some embodiments, the sliding door requires little room during opening, and thus the cross-section of the elevator shaft is available with relatively little obstruction for the cross-section of the elevator cage.

Embodiments of sliding doors disclosed herein can bring the following advantages:
Little space is demanded, so the elevator shaft can be utilized to a high degree for a largest possible elevator cage.
A low-noise drive can be realized, which drives each individual door panel.
A cage closure can be realized which for a given cage width makes possible a maximum clear door width.

### BRIEF DESCRIPTION OF THE FIGURES

The disclosed technologies are explained in more detail symbolically and by way of example on the basis of figures. The figures are described conjunctively and in general. The same reference numerals signify the same components and reference numerals with different indices indicate functionally equivalent or identical components.

In that case:

FIG. 1 shows a schematic and sectional illustration of a sliding door;

FIG. 1a shows a schematic and perspective illustration of the sliding door of FIG. 1;

FIG. 2 shows a schematic and sectional illustration of a second variant of embodiment of a sliding door;

FIG. 3 shows a schematic and sectional illustration of a third variant of embodiment of a sliding door; and

FIG. 4 shows a schematic and sectional illustration of the sliding door of FIG. 1, with a drive.

### DETAILED DESCRIPTION

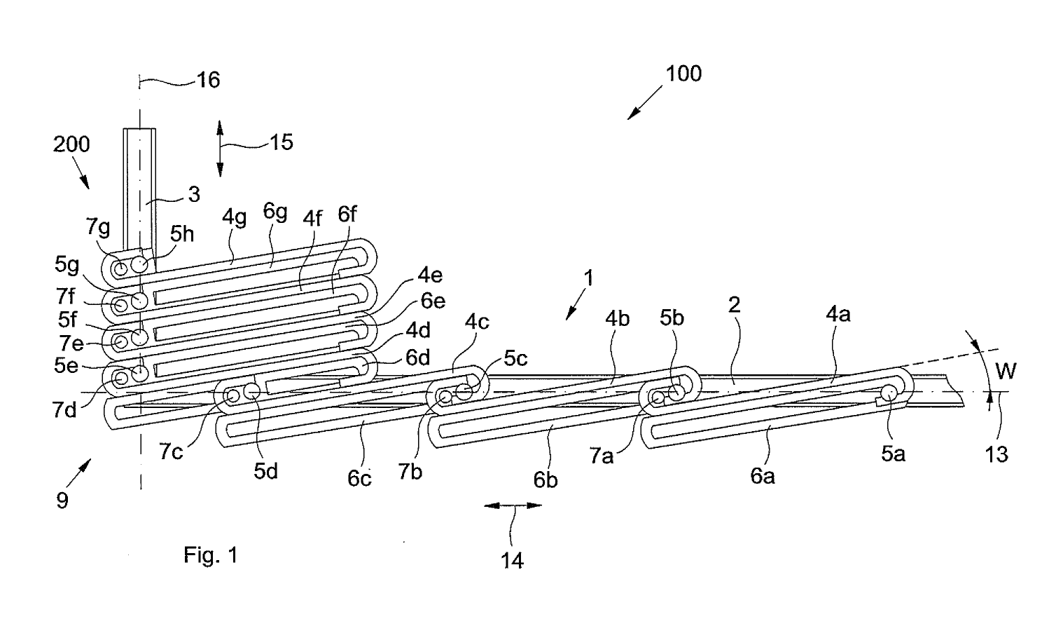

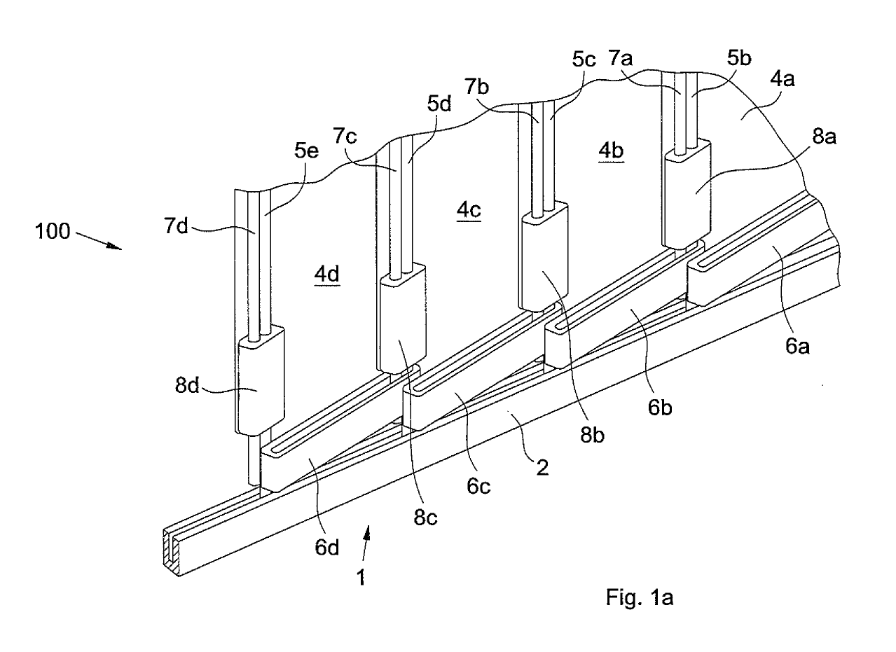

FIG. 1 schematically shows a sectional illustration of a sliding door 100. Door panels 4a-4g are each arranged by means of a respective guide rod 5a-5h in a guide rail 1 with a straight guide rail 2 and a guide rail track 3 angled with respect thereto. The guide rods 5a-5h are each fixedly connected with a respective one of the door panels 4a-4g and can slide along in an opening of a respective gate guide 6a-6g, which are also each fixedly connected with a respective one of the door panels 4a-4g. The door panels 4a-4g partly overlap in the drawn-out state and fully overlap in the closed, stacked state and each form a respective angle W relative to a slide axis 13, wherein the door panels 4a-4n approximately maintain their orientation with respect to the slide axis 13, 13a, 13b during stacking and unstacking. The straight guide rail track 2 and the guide rail track 3 angled with respect thereto form an abutment 9 for the door panels 4a-4g during an opening and closing movement 14 along the side axis 13. Through this abutment 9 and the arrangement of the guide rods 5a-5h in the guide rail 1 and at the same time in the gate guides 6a-6g the door panels 4d-4g were already guided along a stacking axis 16 in a stacking and unstacking movement 15.

A torsion stop 200 is formed in that together with the guide rods 5b-5h a respective torsion rod 7a-7g is fixedly arranged at each of the door panels 4b-4g. It is thereby prevented that the door panel 4g or the door panels 4d-4f stacked in front thereof twist in anticlockwise sense.

The sliding door 100 of FIG. 1 is illustrated in part and schematically in FIG. 1a. Also illustrated are rod mounts 8a-8d which fasten the guide rods 5b-5e and the torsion rods 7a-7d possibly in common to the respective door panels 4a-4d.

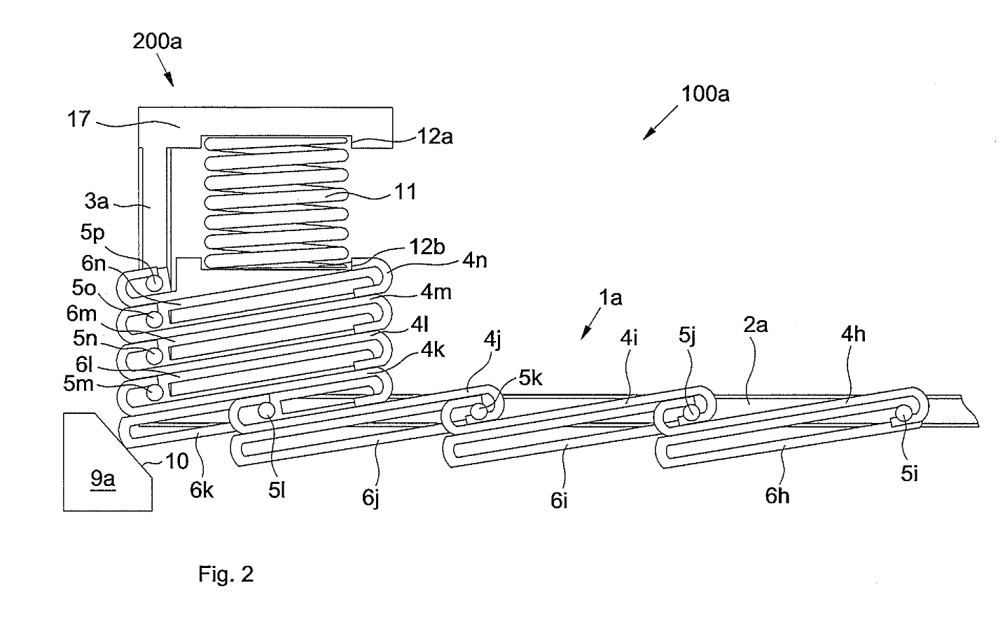

FIG. 2 shows schematically and in section a second variant of embodiment of a sliding door 100a, which is characterized in that an abutment 9a is arranged with an inclined surface 10, which deflects the door panels 4h-4n from a straight guide rail track 2a into a guide rail track 3a, which is angled with respect thereto, of a guide rail 1a. Gate guides 6h-6n, in which guide rods 5i-5o are inserted, are arranged at the door panels 4h-4n.

A torsion stop 200a comprises a spring 11 which, supported in a spring mount 12a of a support 17, presses against the outermost door panel 4n in a spring mount 12b. In this manner not only twisting of the door panel 4n and the previously stacked door panels 4k-4m in anticlockwise sense is prevented, but also guidance of the stacked door panels 4k-4n out of the angled guide rail track 3a into the straight guide rail track 2a during closing movement of the sliding door 100a.

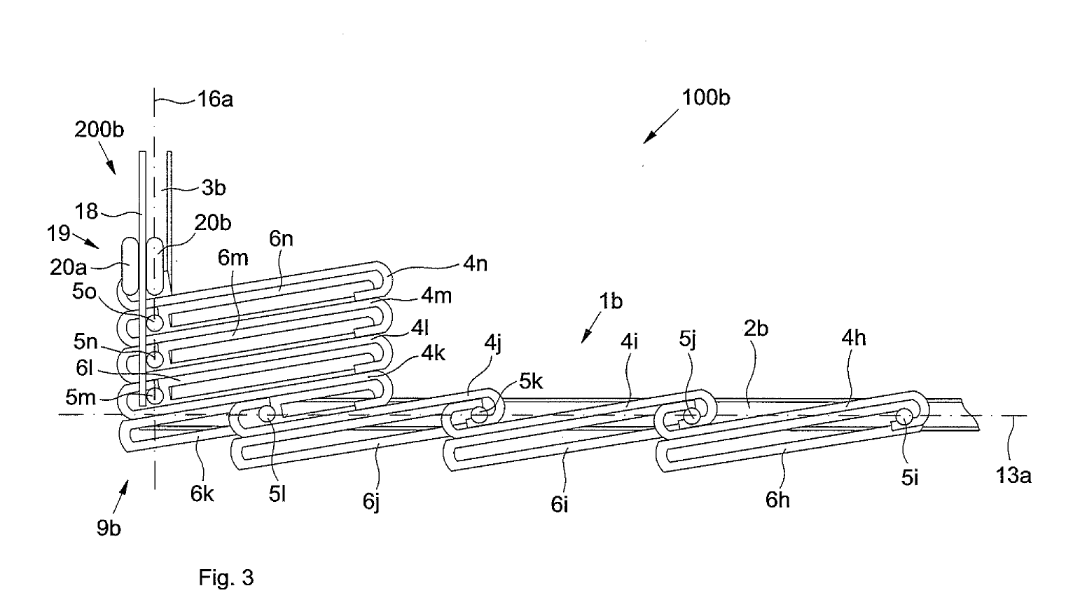

A further embodiment of a sliding door 100b is schematically illustrated in FIG. 3, which is characterized in that a guide rail 1b forms a straight guide rail track 2b and a guide rail track 3b angled relative thereto, wherein a guide blade 18 is correspondingly arranged at the latter parallel to a stacking axis 16a. A guide carriage 19 can slide along this guide blade 18 and thus forms an alternative torsion stop 200b. The guide carriage 19 is fastened to the door panel 4n and can comprise guide elements 20a and 20b of rectangular and elongate form which always grip the guide blade 18 at both sides, even in a completely closed state of the sliding door 100b in which the door panel 4n has arrived at an abutment 9b or on the line of a slide axis 13a.

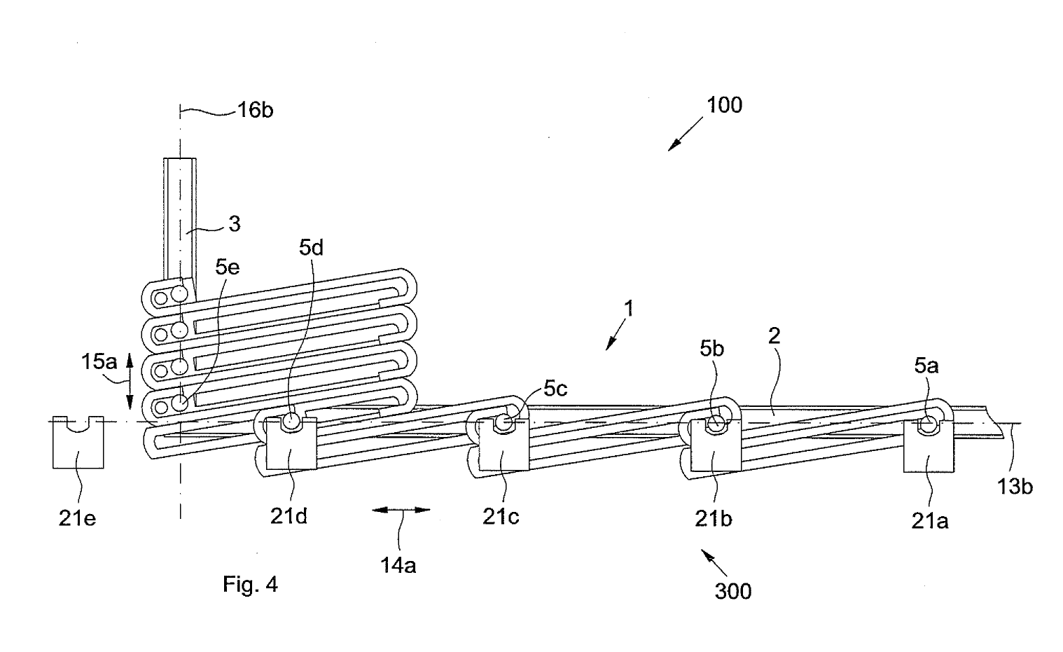

The sectional illustration in FIG. 4 shows with respect to the sliding door 100 of FIG. 1 how a drive 300 is realized. The guide rods 5a-5d or extra pins provided for that purpose are each driven by a respective U-shaped entrainer 21a-21d in correspondence with an opening and sliding movement 14a along a slide axis 13b. The guide rod 5e has already left a U-shaped entrainer 21e in the direction of a stacking and unstacking movement 15a along a stacking axis 16b, insofar as in the opening and closing movement 14a an opening movement progresses to the left. In the case of a closing movement to the right, the guide rod 5e enters the U-shaped entrainer 21e as soon as the U-shaped entrainer 21e is disposed on the line of the stacking axis 16b.

The drive 300 is optimized by the spring-assisted torsion stop 200a of FIG. 2 thanks to a counter-pressure exerted by the guide rods 5a-5e on the U-shaped entrainers 21a-21e. As another embodiment, a closing movement is optimized in that mounted between the entrainers 21a-21e is a slide rail connecting them. The entrainers 21a-21e and the slide rails preferably form a link chain, which is deflectable.

Having illustrated and described the principles of the disclosed technologies, it will be apparent to those skilled in the art that the disclosed embodiments can be modified in arrangement and detail without departing from such principles. In view of the many possible embodiments to which the principles of the disclosed technologies can be applied, it should be recognized that the illustrated embodiments are only examples of the technologies and should not be taken as limiting the scope of the invention. Rather, the scope of the invention is defined by the following claims and their equivalents. I therefore claim as my invention all that comes within the scope and spirit of these claims.

I claim:

1. An elevator sliding door, comprising:
a plurality of door panels, the door panels being oriented along a slide axis and movable along the slide axis in an opening movement, the door panels being stackable along a stacking axis and configured to be deflected by an abutment along the stacking axis, the door panels being configured to be unstacked by deflection along the slide axis in a closing action, the door panels being configured to remain approximately parallel to the slide axis during stacking and unstacking, the panels being configured to be guided by a straight guide rail track of at least one guide rail during the opening movement and the closing movement and to be guided along an angled guide rail track of the at least one guide rail during stacking and unstacking.

2. The elevator sliding door of claim 1, further comprising:
respective gate guides coupled to each of the door panels; and
respective guide rods coupled to each of the door panels, the guide rods being insertable into the at least one guide rail and into respective ones of the gate guides.

3. The elevator sliding door of claim 2, wherein the guide rod is arranged in a rod mount.

4. The elevator sliding door of claim 2, the guide rods comprising guide rollers.

5. The elevator sliding door of claim 2, the gate guides comprising respective detent mechanisms.

6. The elevator sliding door of claim 2, wherein the guide rods are configured to be coupled to respective U-shaped entrainers.

7. The elevator sliding door of claim 1, wherein the door panels are configurable to overlap each other before stacking and after unstacking.

8. The elevator sliding door of claim 1, wherein the door panels are guided in at least two guide rails.

9. The elevator sliding door of claim 1, further comprising a torsion stop, the torsion stop being configured to counter twisting of one or more of the door panels.

10. The elevator sliding door of claim 9, wherein the torsion stop comprises a torsion rod, the torsion rod being configured to be fastened in a rod mount of a guide rod.

11. The elevator sliding door of claim 9, wherein the torsion stop comprises a spring.

12. The elevator sliding door of claim 9, wherein the torsion stop comprises a guide blade and a guide carriage.

13. The elevator sliding door of claim 1, wherein the abutment comprises a slide surface, the slide surface being inclined relative to the slide axis.

14. The elevator sliding door of claim 1, wherein the sliding door is a double sliding door and is configured to be coupled to two drives having opposing operating directions.

15. An elevator installation comprising:
a sliding door, the sliding door comprising a plurality of door panels, the door panels being oriented along a slide axis and movable along the slide axis in an opening movement, the door panels being stackable along a stacking axis and configured to be deflected by an abutment along the stacking axis, the door panels being configured to be unstacked by deflection along the slide axis in a closing action, the door panels being configured to remain approximately parallel to the slide axis during stacking and unstacking, the panels being configured to be guided by a straight guide rail track of at least one guide rail during the opening movement and the closing movement and to be guided along an angled guide rail track of the at least one guide rail during stacking and unstacking.
